(19) United States
(12) Patent Application Publication
(10) Pub. No.: US 2015/0304794 A1
(43) Pub. Date: Oct. 22, 2015

(54) MOBILE DEVICE, SERVICE DEVICE, AND METHODS THEREOF

(71) Applicant: MediaTek Singapore Pte. Ltd., Singapore (SG)

(72) Inventors: Dan LUO, Shaoshanchong (CN); Po-Chun LIN, Taipei City (TW); Mi TANG, Beijing (CN)

(21) Appl. No.: 14/692,025

(22) Filed: Apr. 21, 2015

(30) Foreign Application Priority Data
Apr. 21, 2014 (CN) 201410160766.6

(51) Int. Cl. H04W 4/00; H04L 29/08; H04M 1/02; H04W 76/02

(52) U.S. Cl. CPC H04W 4/003; H04W 76/023; H04L 67/36; H04M 1/0202; H04L 67/2804; H04W 88/06

(57) ABSTRACT

A mobile Device, service device, and service request processing methods thereof are described. The service request processing method is adopted by a service device, includes: establishing, by a touch panel of the service device, a communication channel to a mobile device; receiving, by the touch panel, a service request sent from the mobile device via the communication channel; generating service information according to the service request; and transmitting the service information to the mobile device via the communication channel.

### CROSS REFERENCE TO RELATED APPLICATIONS

This Application claims priority of China Patent Application No. 201410160766.6, filed on Apr. 21, 2014, the contents of which are incorporated by reference herein.

### BACKGROUND OF THE INVENTION

1. Field of the Invention

The present invention relates to touch communication, and in particular to a mobile device, a service device, and a methods thereof.

2. Description of the Related Art

As the rapid growth of information, various data is received or transmitted through wired or wireless transmission technologies in our everyday life. For the wired transmission technology, wireless communication devices are paired up by a connecting mechanism between the wireless communication devices. For the wireless transmission technology, a number of permission configurations defined by certain communication protocols have to be performed before completing the paired-up mechanism, and certain configurations require a user to set them up manually or can be set up automatically. The paired-up procedures adopted by the wired or wireless transmission technologies pose limitations in use and thus cause bad user experience due to complicated process. Consequently, allowing a user to transmit or receive data in a simpler way becomes an important issue for developers.

Near Field Communication (NFC) is a contactless technology for identification and interconnection. Near Field Communication allows users to exchange the information, access contact and services by using the near electric field magnetic communication (such as the near electric field magnetic communication of 13.56 MHz) between the mobile devices, consumer electronics, PCs or smart electronic devices.

Due to the maturity of the market, the mobile phone with NFC can either support the function of the mobile payment or serve as a point of sale (POS). However, the proximity card reader or other similar elements must be added to the handheld device due to the NFC is operated by sending and receiving the signal, and which will make the size of the handheld device becomes larger, and the layout and the elements of the handheld device might be limited.

A touch link technology of the touch panel device which uses the existing panel and driver IC for communication has been developed recently, and has been described in U.S. 2011/0304583, U.S. 2013/0147760, CN 102916729A. The touch panel device includes a touch sensor. At least a part of the touch sensor includes at least a part of touch panel of the touch panel device. The touch panel can be the touch panel without a display function, such as the touch pad, or with the display function, such as the touch screen. The touch sensor includes the driving electrodes and the sensing electrodes set on the board for forming the capacitor structure. At least one of the driving electrodes and the sensing electrodes is used as the sending electrode, and at least one is used as the receiving electrode. Thus, the signal can be sent and received by the existing electrodes and driver IC of the touch panel device so as to achieve the touch link touch link according to the electric field without additional proximity card reader or other similar elements, thus reducing the size and the cost of the touch panel device.

FIG. 1 is a schematic diagram of touch link s between a first touch panel device 101 and a second touch panel device 102 in accordance with a prior art. As shown in FIG. 1, there are near electric fields 103a and 103b between the first touch panel device 101 and the second touch panel device 102. It should be noted that each of the first touch panel device 101 and the second touch panel device 102 are enabled to send and receive signals. When the first touch panel device 101 transmits signals toward the second touch panel device 102, the communications medium used by the first touch panel device 101 is the electric field portion whose electric field direction is pointing toward the second touch panel device 102 (the near electric field 103a as shown in FIG. 1). In addition, when the second touch panel device 102 transmits signals toward the first touch panel device 101, the communications medium used by the second touch panel device 102 is the electric field portion whose electric field direction is pointing toward the first touch panel device 101. (the near electric field 103ba as shown in FIG. 1). The X channel and the Y channel shown in FIG. 1 may represent the sending electrodes and the receiving electrodes set on the board for forming the capacitor structure.

FIG. 2 is logical block diagram of a touch communications system for achieving the touch link system between the first touch panel device 101 and the second touch panel device 102 in accordance with the prior art. The first touch panel device includes a message transmission system 201 shown in FIG. 2, and the second touch panel device includes a message reception system 202 shown in FIG. 2. The message transmission system 201 includes a touch link request signal generating unit 211, a communication connection establishing unit 212 and a first communication unit 213. The touch link request signal generating unit 211 may be arranged to generate a touch link request signal for sending touch link to the second touch panel 102 through the sending electrode. The communication connection establishing unit 212 establishes a communication connection with the second touch panel device 102 after the receiving electrodes receives a response signal from the second touch panel device 102. The first communication unit 213 sends the communication information or the data to the second touch panel device 102 through the sending electrodes after the communication connection is established.

The message reception system 202 includes a touch link request acknowledging unit 221, a communication connection establishing unit 222 and a second communication unit 223. The touch link request acknowledging unit request response unit 221 responds an acknowledge signal to the first touch panel device 101 through the sending electrodes after the receiving electrodes receive a touch link request signal sent from the first touch panel device 101. The communication connection establishing unit 222 establishes the communication connection with the first touch panel device 101 after the touch link request acknowledging unit 221 responses the acknowledge signal to the first touch panel device 101. The second communication unit 223 receives the communication information or the data sent from the first touch panel device 101 through the receiving electrodes after the communication connection is established.

FIG. 3 illustrates a first touch panel 301 of the first touch panel device 101 shown in FIG. 1 and a second touch panel 302 of the second touch panel device 102 shown in FIG. 1 according to the related art. As shown in FIG. 3, each touch panel of the first touch panel 301 and the second touch panel 302 may comprise a touch sensor (not completely shown in FIG. 3). For example, the touch sensor of the first touch panel 301 may comprise a set of transmitting electrodes installed on at least one substrate of the first touch panel 301 (e.g. the transmitting electrode 311) for transmitting signals, and may comprise a set of receiving electrodes installed on at least one substrate of the first touch panel 301 (e.g. the receiving electrode 312) for receiving signals. In another example, the touch sensor of the second touch panel 302 may comprise a set of transmitting electrodes installed on at least one substrate of the second touch panel 302 (e.g. the transmitting electrode 321) for transmitting signals, and may comprise a set of receiving electrodes installed on at least one substrate of the second touch panel 302 (e.g. the receiving electrode 322) for receiving signals.

FIG. 4 is a flow chart of the touch link method in accordance with the prior art. First, at step S401, the touch link request signal generating unit 211 generates a touch link request signal, and sends to the second touch panel device 102 through the sending electrodes. Then the receiving electrodes receive the acknowledge signal responded from the second touch panel device 102 (step S402). After that, the communication connection establishing unit 212 establishes the communication connection with the second touch panel device 102 (step S403). Finally, the method goes to the step S404, the first communication unit 213 sends the communication information or the data to the second touch panel device 102 through the sending electrodes. the first touch panel 301 and the second touch panel 302 further include a touch sensor (not fully shown in FIG. 3). The touch sensor includes the sending electrodes 311, 321 and the receiving electrodes 312, 322 disposed on the board for forming capacitor structure. The sending electrodes 311, 321 are arranged to send the signal, and the receiving electrodes 312, 322 are arranged to receive the signal.

### BRIEF SUMMARY OF THE INVENTION

The disclosure provides an application for the touch connection which allows a user to use a mobile device to request service information on demand from service device via a touch connection, and the service device can generate service information based on the user demand, and respond with the service information to the mobile device, thereby providing a safer and more convenient data transfer.

A detailed description is given in the following embodiments with reference to the accompanying drawings.

An embodiment of a service request processing method is described, adopted by a service device, comprising: establishing, by a touch panel of the service device, a communication channel to a mobile device; receiving, by the touch panel, a service request sent from the mobile device via the communication channel; generating service information according to the service request; and transmitting the service information to the mobile device via the communication channel.

Another embodiment of a service request processing method is disclosed, adopted by a mobile device, comprising: receiving input information to generate a service request; establishing, by a touch panel of the mobile device, a communication channel to a service device; transmitting the service request to the service device via the communication channel; and receiving service information corresponding to the service request via the communication channel.

An embodiment of a service device is described, comprising a touch panel, a touch link module and a service request processing module. The touch link module is configured to establish a communication channel to a mobile device via the touch panel, and receive a service request sent from the mobile device via the communication channel. The service request processing module, coupled to the touch link module, is configured to receive the service request from the touch link module and generate service information according to the service request. Then the touch link module is further configured to transmit the service information to the mobile device via the communication channel.

An embodiment of a mobile device is provided, comprising a service request input module, touch panel and a touch link module. The service request input module is configured to receive input information to generate a service request. The touch link module is configured to establish a communication channel to a service device, transmit the service request to the service device via the communication channel, and receive service information corresponding to the service request via the communication channel

### BRIEF DESCRIPTION OF THE DRAWINGS

The present invention can be more fully understood by reading the subsequent detailed description and examples with references made to the accompanying drawings, wherein:

FIG. 1 is a schematic diagram of touch link s between a first touch panel device and a second touch panel device in accordance with a prior art;

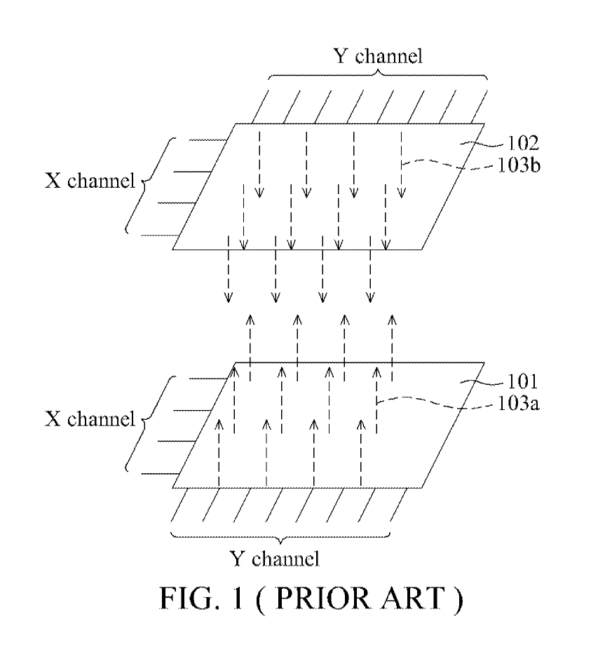

FIG. 2 is a logical block diagram of a touch communications system for achieving the touch link system between the first touch panel device and the second touch panel device in accordance with the prior art;

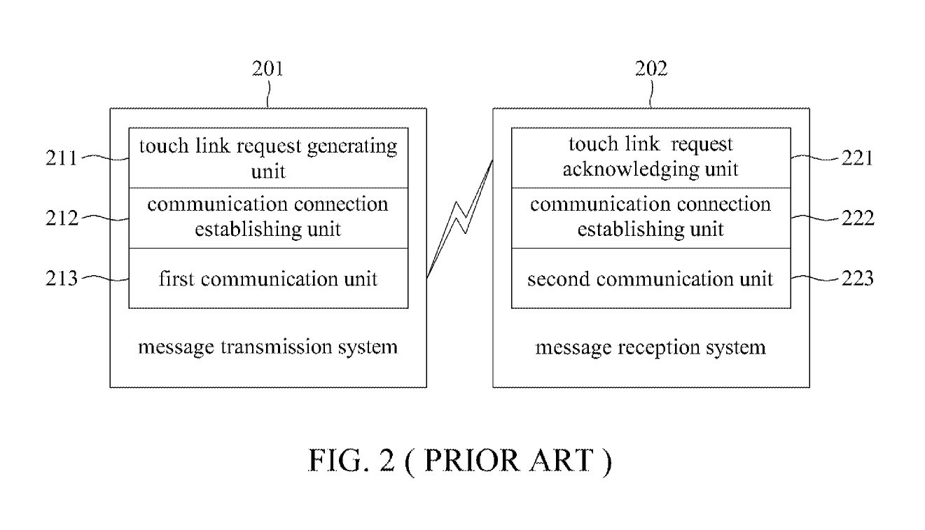

FIG. 3 illustrates a first touch panel of the first touch panel device shown in FIG. 1 and a second touch panel of the second touch panel device shown in FIG. 1 according to the related art;

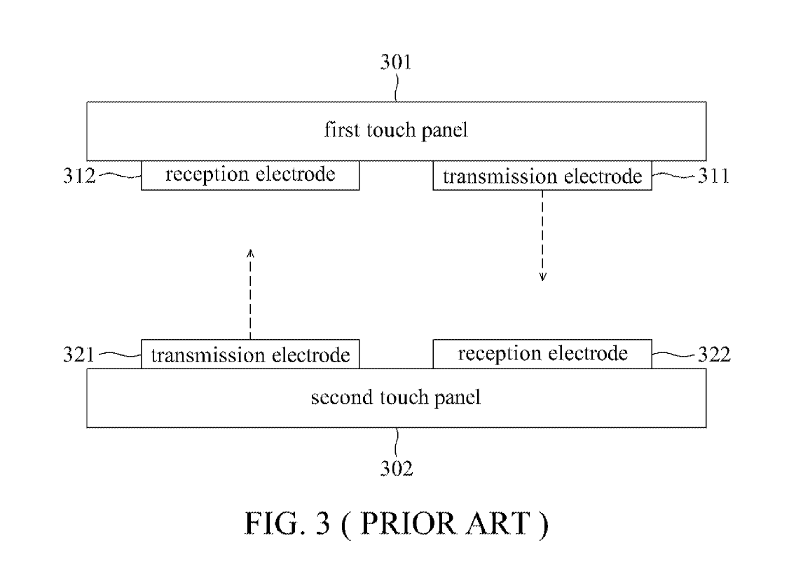

FIG. 4 is a flow chart of the touch link method in accordance with the prior art;

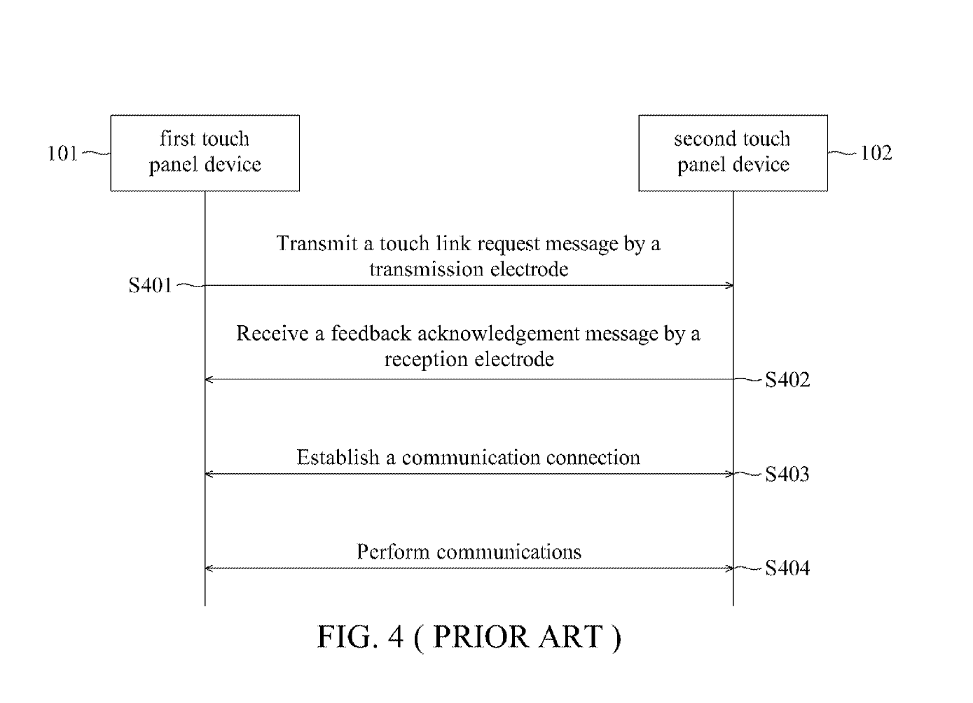

FIG. 5 is a block diagram of a mobile device 14 and service device 16 according to an embodiment of the invention;

FIG. 6 is a flowchart of a method for processing a service request according to an embodiment of the invention;

FIG. 7 is a flowchart of a method for processing a service request according to an embodiment of the invention;

FIG. 8 is a schematic of a shopping request processing method according to an embodiment of the invention;

FIG. 9 is a schematic of a shopping request processing method according to another embodiment of the invention; and

FIG. 10 is a schematic of a service request processing method for public transportation according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

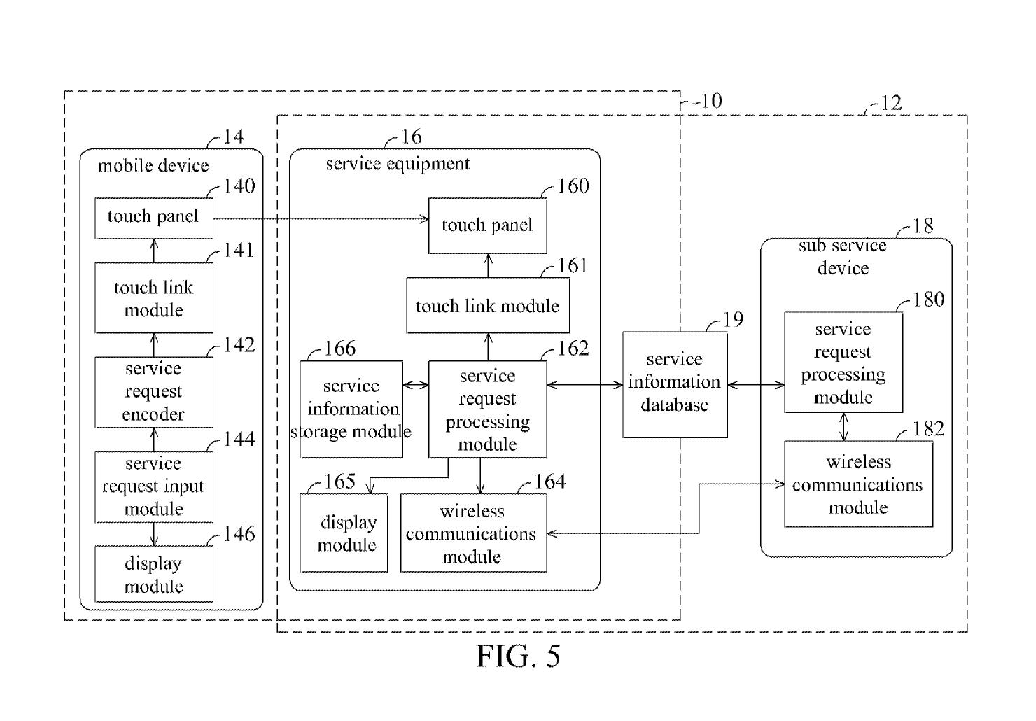

FIG. 5 is a block diagram of a mobile device 14 and service device 16 according to an embodiment of the invention. The mobile device 14 may be a Personal Digital Assistant (PDA), smart watch, smart phone, smart home appliance, notebook computer, tablet, television, printer, electronic reader, or any electronic device which is equipped with a touch link module (such as a touch integrated circuit) and a request can be written thereto. The service device 16 may be a server, public transport information board, supermarket or store information station, or any mobile or fixed equipment that is equipped with a touch link module (such as a touch integrated circuit) and provides electronic information. When the distance between the mobile device 14 and the service device 16 is in the scale of millimeters (e.g. 5 millimeters), the two devices are regarded as physically nearby, and a touch link may be established between the mobile device 14 and the service device 16 to form a first connection range 10. It is noted that the service device 16 may establish wired or wireless connections to one or more sub service device (such as the sub service device 18) or service information database 19) to form a second connection range 12, wherein the wired connection may be an Ethernet connection, and the wireless connection may be a WiFi or Bluetooth connection.

When a user wishes to request a service from the service device that has been established the touchlink, the user may firstly input information (such as a request list) into the mobile device 14, which may convert the information into a formal service request, and then the mobile device 14 transmits the service request to the service device 16 via the touch link. On the other hand, once the service request is received through the touch link, the service device 16 can generate the service information according to the service request, and send the service information back to the mobile device 14 through the touch link. The mobile device 14 may display the service information for the user, and the service device 16 may also display the service information or service request thereon. In some embodiments, the service device 16 will not transmit the service information back to the mobile device 14 but directly display the service information on the display module. In other embodiments, the service device 16 will not directly generate the service information based on the service request, rather, the service device 16 can acquire the service information from a service information database, or redirect the service request to the sub service device 18 to request the sub service device to generate the service information based on the service request, and subsequently, the service device 16 can receive the service information from the sub service device 18 and send the service information to the mobile device 14 via the touch link.

As shown in FIG. 5, the mobile device 14 includes a touch panel 140, a touch link module 141, a service request encoder 142, a service request input module 144 and a display module 146. The touch link module 141 establishes the communication channel between the mobile device 14 and the service device 16 via the touch panel 140 and transmits the service request through the communication channel. The service request input module 144 receives the information entered by a user, e.g., a shopping list, a traveling route, etc. The service request encoder 142 encodes the information entered by a user, such as a request list, to generate a formal service request. Moreover, the touch link module 141 may receive the service information corresponding to the service request from the service device 16. The display module 146 may display the received service information, as well as the information entered by a user or the generated service request.

The service device 16 includes a touch panel 160, a touch link module 161, a service request processing module 162, a wireless communications module 164, a display module 165 and a service information storage module 166, wherein the service information storage module 166 is optional. The touch link module 161 establishes the communication channel between the mobile device 14 and the service device 16 via the touch panel 160, and receives the service request through the communication channel. The service request processing module 162 processes the service request to generate the service information. Specifically, the service request processing module 162 may access the service information corresponding to the service request from the service information storage module 166 according to the decoded service request. Furthermore, the service request processing module 162 may also obtain the corresponding service information from a service information database 19 according to the service request, wherein the service request processing module 162 has established a wireless connection with the service information database 19. In some embodiments, the service request processing module 162 matches the service request to the data in the service information database 19 to generate the service information. The display module 165 displays the generated service information, as well as the received service request along with other information. Since the wireless communications module 164 may connect to one or more sub service devices (such as the sub service device 18), in some embodiments, when the service request processing module 162 determines that it cannot generate service information corresponding to the service request, the service device may send the service request to one or more sub service devices (such as the sub service device 18) that is connected to the service device. The sub service device 18 may produce the corresponding service information and the service device 16 may receive the service information from the sub service device 18 via the wireless connection. The service device 16 utilizes the wireless communications module 164 to communicate with the sub service device for the service request and service information. The service information received from the service information database and other sub service device may be stored into the service-information storage module 166.

The sub service device 18 includes a service request processing module 180 and a wireless communications module 182. The sub service device 18 employs the wireless communications module 182 to establish wireless connections with one or more service devices (such as the service device 16), and transmits service information to one or more service devices via the wireless connections. The wireless communications module 182 may also receive a service request from the service device 16, which is used by the service request processing module 180 to provide the service information, and then the wireless communications module 182 sends the service information back to the service device 16.

In FIG. 5, the mobile device 14 and the service device 16 establish a touch link by a touch and exchange a service request and service content, allowing a user to ask for service information from the service device 16 via the mobile device 14, providing a quicker and safer data transfer.

Obviously, when devices make communications through a touch link, one mobile device may touch with one service device, or multiple mobile devices may touch with one service device and each mobile device sends a service request to the service device.

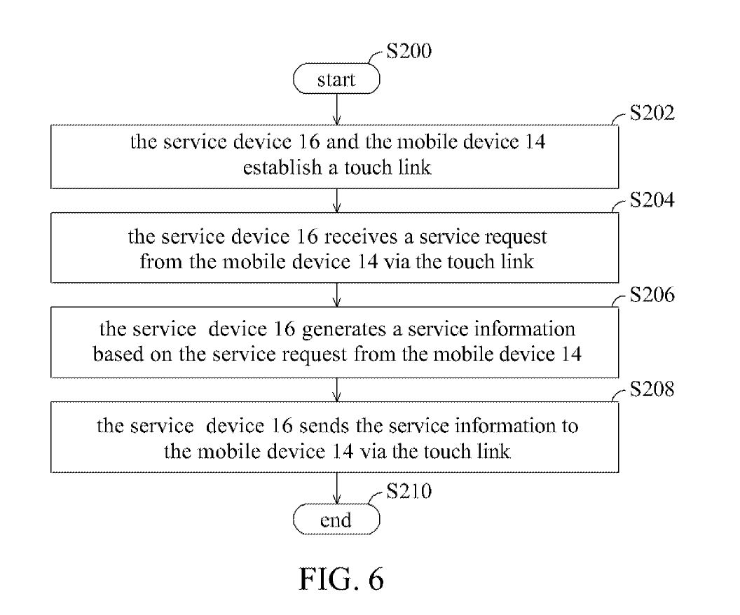

FIG. 6 is a flowchart of a method 2 for processing a service request according to an embodiment of the invention, adopted by the service device 16. The method 2 may be triggered when the service device 16 detects a touch link from another touch link device.

After the method 2 starts, the service device 16 detects the mobile device 14 and establishes a touch link between the service device 16 and the mobile device 14 (Step S202). In practice, the service device 16 may establish touch links with one or more mobile devices.

Next, the service device 16 receives the service request from the mobile device 14 via the touch link (Step S204). The service request may include a shopping list or a traveling route written into the mobile device 14. For example, a shopping list includes toothpastes, washing powder, toilet cleaner, dishwasher, cleaner, towels and so on. And the traveling route may include the start and destination of a trip.

Upon receiving the service request, the service device 16 can generate the service information according to the service request (Step S206). In some embodiments, the service device 16 may access the service information corresponding to the service request from the service information storage module 166. In other embodiments, the service device 16 may acquire data from the service information database 19 to generate the service information. In yet other embodiments, the service device 16 may transmit the service request to one or more sub service devices (such as the sub service device 18), which processes the service request and generates the corresponding service information, the service device 16 then may receive the service information from one or more sub service devices (such as the sub service device 18). The service information may be a picture, an image or text.

The service device 16 may directly display the service information on the display module 165 for the user, or pass the service information to the mobile device 14 via the touch link (Step S208), and then displays the service information on the display module 146 for use of the user.

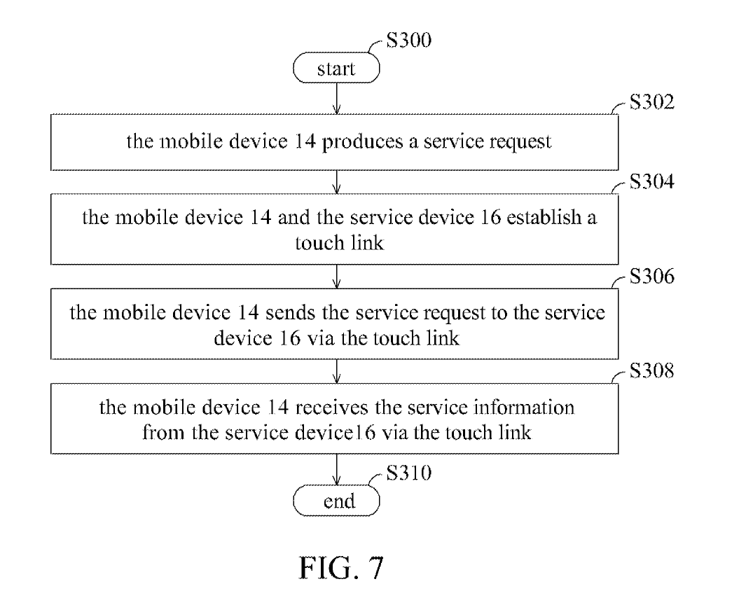

FIG. 7 is a flowchart of a method 3 for processing a service request according to an embodiment of the invention, adopted by the mobile device 14 in FIG. 5.

After the method 3 starts, the mobile device 14 receives a service list inputted by a user, which is used to generate a service request (Step S302). The service request may include a shopping list or a traveling route written into the mobile device 14. For example, a shopping list includes toothpastes, washing powder, toilet cleaner, dishwasher, cleaner, towels and so on. The traveling route may include the start and destination of a trip. In some embodiments, the service request encoder 142 can encode the service list to generate the service request.

Next, the mobile device 14 moves into the detection range of the service device 16, and the mobile device 14 detects the nearby service device 16 and establishes a touch link therebetween (Step S304). In practice, the service device 16 may establish touch links with one or more mobile devices.

Then the mobile device 14 sends the service request to the service device 16 via the touch link (Step S306), and subsequently, the mobile device 14 receives the service information from the service device 16 via the touch link, wherein the service information corresponds to the service request (Step S308). The mobile device 14 can display the service information on the display module 146 for the user. The service information may be a picture, an image or text.

The methods of processing the service request in FIGS. 6 and 7 establish a touch link and provide exchanges of the service requests and service content, allowing a user to ask for the service information from the service device 16 via the mobile device 14, and providing a faster and safer way to transfer data.

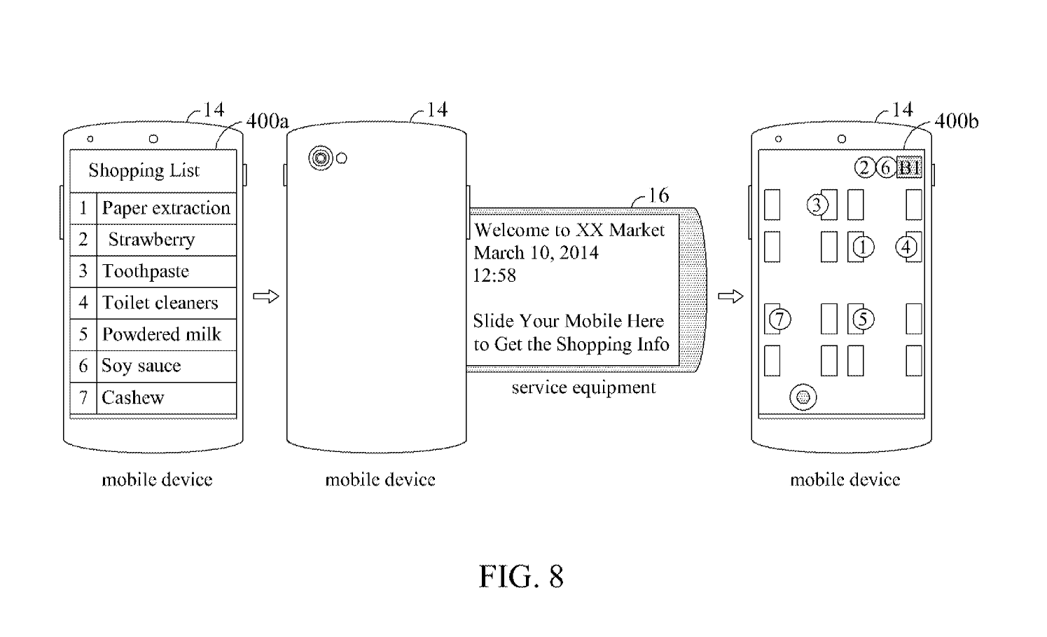

FIG. 8 is a schematic of a shopping request processing method according to an embodiment of the invention, adopted in a map application for a supermarket.

First, a user may compose a shopping list 400a via an application on a handset (mobile device 14), and then lean the touch screen of the handset close to a touch screen of a fixed or mobile information station (i.e., service device 16) to establish a touch link. Then the composed shopping list (service request) is transmitted to the information station via the touch link. The fixed electronic information station may be electronic equipment fixed at a specific location (such as the entry) in the supermarket. The mobile electronic information station may also be electronic equipment fixed at the supermarket trolleys or baskets.

On the other hand, after receiving the shopping list 400a, the fixed or mobile information station may match each item in the shopping list 400a to all item information in a service information database 19 to generate a shopping map 400b (service information). The item information in the service information database 19 may include a product name sold in the supermarket and the corresponding display location. The shopping map 400b shows the display locations in the supermarket for all items in the shopping list 400a.

The electronic information station then automatically returns the shopping map 400b to the handset via the touch link. In response, the handset may display the shopping map 400b on the display thereof for a user to find all items in the shopping list.

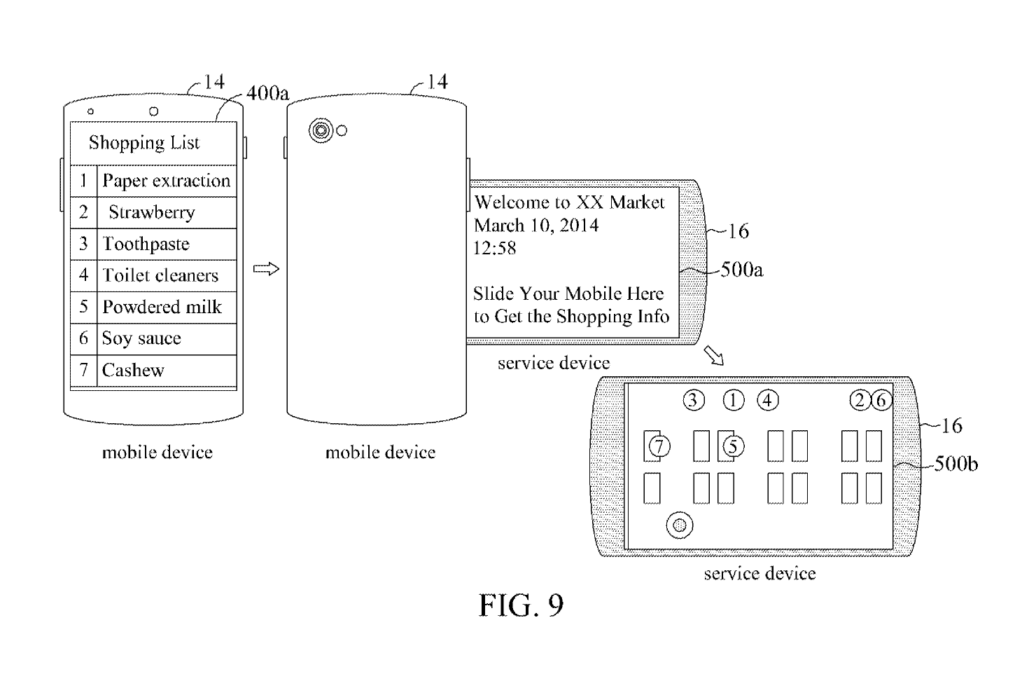

FIG. 9 is a schematic of a shopping request processing method according to another embodiment of the invention, adopted in a map application for a supermarket.

A supermarket may introduce one or more electronic information stations (such as the service device 16), a handset may acquire a view of a shopping map 500a with a touch link.

A user may compose a shopping list 400a via an application on the handset (mobile device 14), and then lean the touch screen of the handset close to a touch screen of a fixed or mobile electronic information station (i.e., service device 16) to establish a touch link. Then the composed shopping list (service request) is transmitted to the electronic information station via the touch link. The fixed electronic information station may be electronic equipment fixed at a specific location in the supermarket. The mobile electronic information station may also be electronic equipment fixed at the supermarket trolleys or baskets.

On the other hand, after receiving the shopping list 400a, the electronic information station may match each item in the shopping list 400a to all item information in a service information database 19 to generate a shopping map 500b (service information). The item information in the service information database 19 may include a product name sold in the supermarket and the corresponding display location. The shopping map 500b shows the display locations in the supermarket for all items in the shopping list 400a.

The electronic information station then directly shows the shopping map 500b on the display thereof for a user to find all items in the shopping list.

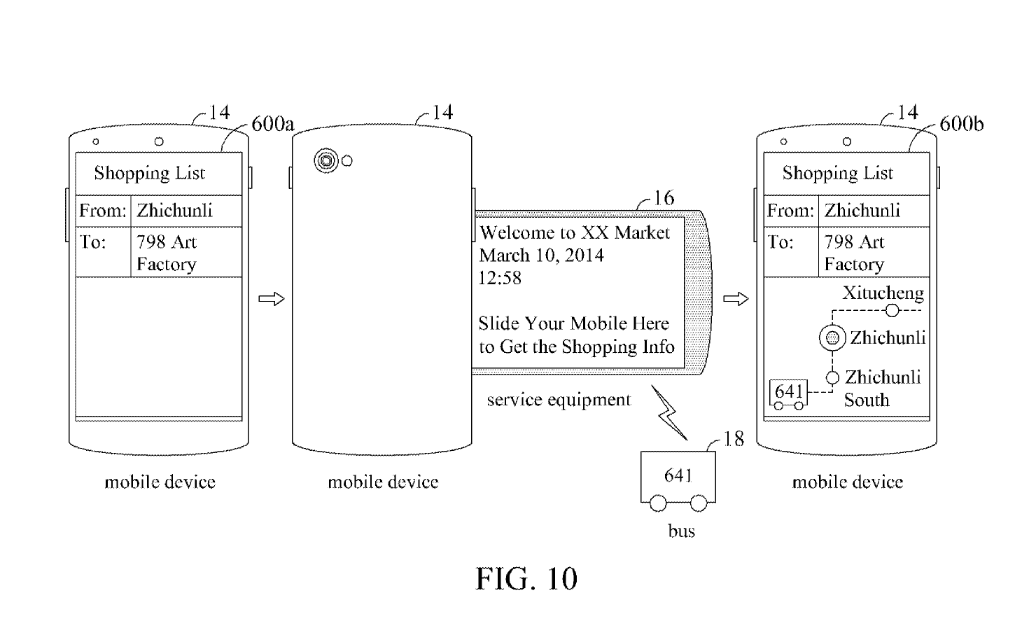

FIG. 10 is a schematic of a service request processing method for public transportation according to an embodiment of the invention, adopted by a map application at a bus stop.

First, a user may compose a traveling route 600a via an application on a handset (mobile device 14), and then lean the touch screen of the handset close to a touch screen of a bus information board (i.e., service device 16) to establish a touch link, Then the composed traveling route 600a (service request) is transmitted to the bus information board via the touch link. The traveling route 600a may include a start location and destination location of a trip. For example, the start location may be Zhichunli, the destination location may be 798 Art Factory.

Correspondingly, after receiving the traveling route 600a, the bus information board may issue requests to all buses wirelessly connected to the bus electronic information board according to the start and destination locations in the traveling route 600a. In response to each request, the buses will transmit their current positions to the bus electronic information board via the wireless connection. Subsequently, the bus electronic information board can determine the first arriving bus and the distance from the bus information board (service information) according to all collected bus locations, and convert the service information into a bus map 600b, which is sent to the handset via the touch link. For example, bus (sub service device) 641 receives a request from the bus information board and responds with its current location via a WiFi connection. After receiving the locations of several buses (not shown), the bus electronic information board determines that bus 641 is the first bus that will arrive at the bus stop, and converts the bus information of bus 641 into a bus map 600b and sends the bus map 600b to the handset through the touch link.

The handset then may display the bus map 600b on its display for a user to identify bus information of the bus that will take the user to the destination.

As used herein, the term “determining” encompasses calculating, computing, processing, deriving, investigating, looking up (e.g., looking up in a table, a database or another data structure), ascertaining and the like. Also, “determining” may include resolving, selecting, choosing, establishing and the like.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or another programmable logic device, discrete gate or transistor logic, discrete hardware components or any combination thereof designed to perform the functions described herein. A general purpose processor may be a microprocessor, but in the alternative, the processor may be any commercially available processor, controller, micro controller or state machine.

The operations and functions of the various logical blocks, modules, and circuits described herein may be implemented in circuit hardware or embedded software codes that can be accessed and executed by a processor.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A service request processing method, arranged for a service device, comprising:
establishing, by a touch panel of the service device, a communication channel to a mobile device;
receiving, by the touch panel, a service request sent from the mobile device via the communication channel;
generating service information according to the service request; and
transmitting the service information to the mobile device via the communication channel.

2. The service request processing method of claim 1, wherein the step of generating the service information according to the service request comprises:
acquiring the service information from a service information storage module of the service device according to the service request.

3. The service request processing method of claim 1, wherein the step of generating the service information according to the service request comprises:
acquiring the service information from a service information database service device according to the service request.

4. The service request processing method of claim 1, wherein the step of generating the service information according to the service request comprises:
establishing, by a wireless communication module of the service device, a wireless connection to a sub service device;
transmitting the service request to the sub service device via the wireless connection; and
receiving the service information corresponding to the service request from the sub service device.

5. The service request processing method of claim 1, further comprising:
displaying, by a display module of the service device, the service request or the service information.

6. A service request processing method, arranged for a mobile device, comprising:
receiving input information to generate a service request;
establishing, by a touch panel of the mobile device, a communication channel to a service device;
transmitting the service request to the service device via the communication channel; and
receiving service information corresponding to the service request via the communication channel.

7. The service request processing method of claim 6, further comprising:
displaying, by a display module of the mobile device service device, the service request or the service information.

8. The service request processing method of claim 6, further comprising:
encoding, by a service request encoding module of the mobile device, the input information to generate the service request.

9. A service device, comprising:
a touch panel,
a touch link module, configured to establish a communication channel to a mobile device via the touch panel, and receive a service request sent from the mobile device via the communication channel;
a service request processing module, coupled to the touch link module, configured to receive the service request from the touch link module and generate service information according to the service request; and
wherein the touch link module is further configured to transmit the service information to the mobile device via the communication channel.

10. The service device of claim 9, further comprising a service information storage module;
wherein the service request processing module is configured to acquire the service information from the service information storage module according to the service request.

11. The service device of claim 9, wherein the service request processing module is configured to acquire the service information from a service information database according to the service request.

12. The service device of claim 9, further comprising:
a wireless communication module, coupled to the service request processing module, configured to establish a wireless connection to a sub service device, transmit the service request to the sub service device via the wireless connection, and receive the service information corresponding to the service request from the sub service device.

13. The service device of claim 9, further comprising:
a display module, configured to display the service request or the service information.

14. A mobile device, comprising:
a service request input module, configured to receive input information to generate a service request;
a touch panel; and
a touch link module, configured to establish a communication channel to a service device, transmit the service request to the service device via the communication channel, and receive service information corresponding to the service request via the communication channel.

15. The mobile device of claim 14, further comprising:
a display module, configured to display the service request or the service information.

16. The mobile device of claim 14, further comprising:
a service request encoding module, configured to encode the input information to generate the service request.
